(19) United States
(12) Patent Application Publication
(10) Pub. No.: US 2025/0266466 A1
(43) Pub. Date: Aug. 21, 2025

(54) CATALYST INK

(71) Applicant: HONDA MOTOR CO., LTD., Tokyo (JP)

(72) Inventors: Shinya SATO, Saitama (JP); Naoki KUSHITANI, Saitama (JP); Takanori IGARASHI, Saitama (JP)

(21) Appl. No.: 19/033,494

(22) Filed: Jan. 22, 2025

(30) Foreign Application Priority Data
Feb. 20, 2024 (JP) 2024-023904

(51) Int. Cl. H01M 4/86; H01M 4/88; H01M 8/10

(52) U.S. Cl. CPC H01M 4/8663; H01M 4/881; H01M 4/8828; H01M 2008/1095

(57) ABSTRACT

A catalyst ink is for forming a catalyst layer by being coated on a surface of an electrolyte membrane of a fuel cell, the catalyst ink including ionomer, catalyst metal particles, carbon and a solvent, in which a solubility parameter of the solvent is greater than 18.0, the solvent includes water and an alcohol at least containing ethanol, and the concentration of ethanol in the solvent is 35% by mass or more.

This application is based on and claims the benefit of priority from Japanese Patent Application No. 2024-023904, filed on 20 Feb. 2024, the content of which is incorporated herein by reference.

### BACKGROUND OF THE INVENTION

### Field of the Invention

The present invention relates to a catalyst ink to be used in the formation of a catalyst layer of a fuel cell.

### Related Art

In recent years, fuel cells which generate electricity by electrochemically reacting hydrogen and oxygen have been receiving attention as a novel power source for automobiles, etc. Fuel cells are said to be preferable in the point of having high power generation efficiency due to obtaining electricity directly from an electrochemical reaction. In addition, fuel cells are said to be preferable from the point of environmental impact due to only generating water during power generation.

The fuel cell includes a membrane electrode assembly configured by sandwiching the electrolyte membrane between a pair of catalyst layers. For example, Japanese Unexamined Patent Application, Publication No. 2023-10955 discloses a catalyst layer containing platinum particles, carbon particles, a polymer electrolyte, etc. The catalyst layer, for example, is formed by coating a catalyst ink containing ionomer, catalyst metal particles, carbon, solvent, etc. as an ion conductive member on the surface of the electrolyte film, and then drying.
Patent Document 1: Japanese Unexamined Patent Application, Publication No. 2023-10955

### SUMMARY OF THE INVENTION

However, there are cases where the catalyst ink coated on the surface of the electrolyte member permeates from the surface of the electrolyte membrane, and dissolution and swelling of the electrolyte membrane occurs. There is concern over cracks, wrinkles, etc. occurring in the catalyst layer formed due to the swelling, etc. of the electrolyte membrane from within the coated catalyst ink.

The present invention has an object of providing a catalyst ink which can form a catalyst layer for which the occurrence of cracks and wrinkles is suppressed.

A catalyst ink according to a first aspect of the present invention is a catalyst ink for forming a catalyst layer by being coated on a surface of an electrolyte membrane of a fuel cell, the catalyst ink including ionomer, catalyst metal particles, carbon and a solvent, in which a solubility parameter of the solvent is greater than 18.0.

According to a second aspect of the present invention, in the catalyst ink as described in the first aspect, the solvent includes water and an alcohol containing at least ethanol, and a concentration of ethanol in the solvent is 35% by mass or more.

According to a third aspect of the present invention, in the catalyst ink as described in the first or second aspect, the carbon includes carbon fiber, and a proportion of the carbon fiber in the carbon in the catalyst ink is greater than 0% by volume and 10% by volume or less.

According to the present invention, it is possible to prepare a catalyst layer for which the occurrence of cracks and wrinkles is suppressed.

### BRIEF DESCRIPTION OF THE DRAWINGS

FIG. 1 is a cross-sectional view showing a membrane electrode assembly of a fuel cell produced using a catalyst ink according to an embodiment of the present invention;

FIG. 2 is a schematic diagram showing a dispersion state of each component in the catalyst ink according to an embodiment of the present invention;

FIG. 3A is a schematic diagram showing a penetration status of solvent in an electrolyte membrane on which a catalyst ink having an SP value of solvent of 18 or less has been coated;

FIG. 3B is a schematic diagram showing a catalyst layer formed by coating of the catalyst ink in FIG. 3A;

FIG. 4A is a schematic diagram showing a penetration status of solvent in the catalyst ink of the electrolyte membrane on which the catalyst ink according to an embodiment of the present invention has been coated;

FIG. 4B is a schematic diagram showing a catalyst layer formed by coating of the catalyst ink in FIG. 4A;

FIG. 5 is a schematic diagram showing a dispersion state of each component in the catalyst ink in which carbon fibers are not contained;

FIG. 6A is a graph showing the relationship between the SP value of the solvent of the catalyst ink and the solvent absorptivity of the electrolyte membrane on which the catalyst ink was coated;

FIG. 6B is a graph showing the relationship between the SP value of the solvent in the catalyst ink and the solvent absorptivity of the electrolyte membrane on which the catalyst ink was coated;

FIG. 7 is a view showing a drop of the catalyst ink coated on the electrolyte member, and is an explanatory diagram for describing a method for obtaining the solvent absorptivity of the electrolyte membrane;

FIG. 8 is a graph showing the relationship of viscosities of the catalyst ink according to an embodiment of the present invention and a catalyst ink in which carbon fibers are not contained, with the shear velocity;

FIG. 9 is a graph showing particle size distributions of the catalyst ink according to an embodiment of the present invention and a catalyst ink in which carbon fibers are not contained;

FIG. 10 is a graph showing the hardness of a catalyst layer formed by the catalyst ink according to an embodiment of the present invention and by a catalyst ink in which carbon fibers are not contained;

FIG. 11 is a graph showing the relationship between a proportion of carbon fiber to carbon within the catalyst layer and a crack occurrence rate.

### DETAILED DESCRIPTION OF THE INVENTION

Hereinafter, embodiments of the present invention will be described while referencing the drawings. However, the embodiments shown below are exemplifying the present invention, and the present invention is not to be limited to the following embodiments.

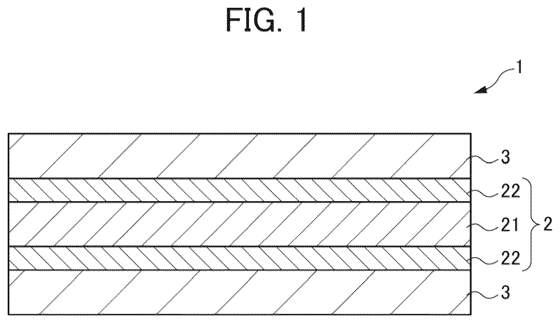

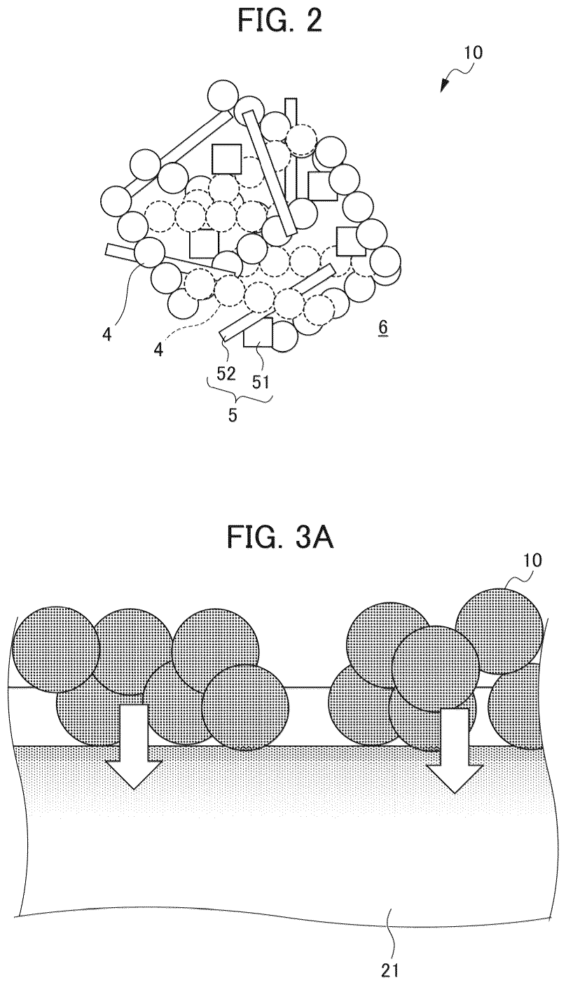

A catalyst ink 10 according to the present embodiment and a fuel cell 1 prepared using the catalyst ink 10 will be described while referencing FIGS. 1 and 2. FIG. 1 is a cross-sectional view showing a membrane electrode assembly 2 of a fuel cell 1 produced using the catalyst ink 10. FIG. 2 is a schematic diagram showing a dispersion state of each component in the catalyst ink 10; First, the fuel cell 1 produced using the catalyst ink 10 according to the present embodiment will be described while referencing FIG. 1.

### (Fuel Cell)

The fuel cell 1 is a solid polymer fuel cell that generates electricity by reacting hydrogen and oxygen, and mainly includes a membrane electrolyte assembly 2 and a gas diffusion layer 3. The solid polymer fuel cell has advantages in having low operating temperature, short startup time, and being compactly configurable, and is practically used in the field of drive power sources of automobiles, etc.

The membrane electrode assembly 2 has an electrolyte membrane 21, and a pair of catalyst layers 22 arranged to oppose and sandwich the electrolyte membrane 21. The catalyst ink 10 is used in the formation of the catalyst layer 22.

The electrolyte membrane 21 is a proton conductive film made by forming a polymer belonging to cation exchange resin and possessing a proton conduction property, into a film shape. As the cation exchange resin, for example, a sulfonated substance of a vinyl polymer such as polystyrene sulfonate; polymers to which a sulfonate group or phosphate group have been introduced to a heat resistant polymer such as perfluoroalkyl sulfonate polymer, perfluoroalkyl carboxylate polymer, polybenzimidazole, and polyether ether ketone; polymers with a main component of polyphenylene obtained by polymerizing an aromatic compound consisting of phenylene chains, and made by introducing a sulfonate group thereto, etc. can be exemplified.

The catalyst layer 22 is configured to include catalyst metal particles (omitted from illustrations), an ionomer 4 which is a polymer electrolyte (omitted from illustration in FIG. 1), and carbon 5 (omitted from illustration in FIG. 1). Among the pair of catalyst layers 22, one functions as the anode of the fuel cell 1, and the other one functions as the cathode.

The catalyst metal particles are not particularly limited as long as having catalytic activity; however, platinum and platinum alloys can be exemplified thereas. If using platinum alloy, it can also impart stability and activity to the electrode catalyst. As the platinum alloy, it is preferably an alloy of platinum with at least one metal selected from the group consisting of platinum group metals other than platinum (ruthenium, rhodium, palladium, osmium, iridium), cobalt, iron, titanium, gold, silver, chromium, manganese, molybdenum, tungsten, aluminum, silicon, rhenium, zinc, and tin, and an intermetallic compound with a metal alloyed with platinum may be contained in this platinum alloy.

The catalyst layer 22 is formed by coating the catalyst ink 10 onto the surface of the electrolyte membrane 21 and drying. The method of coating the catalyst ink 10 is not particularly limited, and can utilize various coating methods. As the coating method, for example, bar coater coating, knife coater coating, die coat coating, doctor blade method, screen printing, spray coating, etc. can be exemplified. The ionomer 4 and the carbon 5 are included in the catalyst ink 10, and the details thereof are described later.

The gas diffusion layer 3 is configured by a porous sheet member. The sheet member, for example, may be nickel foam, carbon cloth, or the like. The gas diffusion layer 3 is arranged on a surface of the catalyst layer 22 on the opposite side to the electrolyte membrane 21.

### (Catalyst Ink)

Next, the catalyst ink 10 will be described while referencing FIG. 2. The catalyst ink 10 is a liquid mixture containing the aforementioned catalyst metal particles, the ionomer 4, the carbon 5, and a solvent 6.

The ionomer 4 is used in the electrode reaction of the catalyst layer 22, and the conducts ions generated thereby. As the ionomer 4, for example, a polymer including an ion-exchange group, which is a fluorine-based polymer in which at least part of the polymer skeleton is fluorinated, or a hydrocarbon-based polymer which is free of fluorine in the polymer skeleton, can be exemplified. As the ionomer 4, a fluorine-based ionomer 4 which is a fluorine-based polymer is preferable. In addition, the type of this ion exchange group is not particularly limited, and can be arbitrarily selected according to the application. As the ion exchange group, for example, sulfonic acid, carboxylic acid, phosphonic acid, etc. can be exemplified. It should be noted that, for convenience, FIG. 2 shows the ionomer 4 by both a plurality of continuous solid line circles, and continuous broken line circles, so that it can be understood that the plurality of ionomers 4 are dispersed.

The carbon 5 can adopt carbon black, graphite, carbon fiber, activated carbon, etc., the pulverized product of these, carbon nanofiber, carbon nanotubes, and carbon compounds such as carbon nitride, carbon sulfide and carbon phosphide.

The carbon 5 is generally classified into non-fibrous carbon particles 51 such as carbon black, and fibrous carbon fiber 52. This functions as a conductive carrier which supports the catalyst metal particles on the carbon particles 51. The conductive carrier is not particularly limited so long as possessing electrical conductivity and moderate corrosion resistance; however, it is desired to have sufficient specific surface area for highly dispersing the catalyst metal particles, and to have sufficient electron conductivity.

The carbon 5 on which the catalyst metal particles are supported may use a prepared product, or may use a commercially available product. In the case of preparing the carbon 5 on which the catalyst metal particles are supported, the preparation method thereof is not particularly limited, and a conventional, known method can be used. As conventional, known preparation methods, for example, a method such that adds a solution or suspension of a platinum compound to carrier powder, evaporative drying, followed by insolubilizing with acid or alkali, then reduction treating to activate the supported component can be exemplified. In the present embodiment, the catalyst metal particles are only supported on the carbon particles 51; however, the catalyst metal particles may be supported on both the carbon particles 51 and the carbon fiber 52.

The carbon fiber 52, for example, preferably has a fiber diameter of 100 nm to 200 nm, and a fiber length of 10 μm to 50 μm. As the carbon fiber 52, for example, multilayer carbon nanotubes are preferable. As the multilayer carbon nanotubes, for example, vapor grown carbon fiber (VGCF: Vapor Grown Carbon Fiber) is preferable. As multilayer carbon nanotubes other than VGCF, the multilayer carbon nanotubes in NTDWK010 (Hamamatsu Carbonics Corp., Co. Ltd.) or the like can be exemplified.

The proportion of carbon fiber 52 in the carbon 5 in the catalyst ink 10, for example, may be greater than 0% by volume and 20% by volume or less, or may be 5.0% by volume or more and 20% by volume or less. It is thereby possible to enhance the dispersibility of the ionomer 4 in the catalyst ink 10. The proportion of the carbon fiber 52 in the carbon 5 in the catalyst ink 10 is preferably greater than 0% by volume and 10% by volume or less, and is more preferably 5.0% by volume or more and 10% by volume or less, from the viewpoint of enhancing the dispersibility of the ionomer 4.

The solvent 6 is a medium which disperses the ionomer 4 and the carbon 5. The solvent 6 is preferably a mixed solvent containing water and alcohol. As the alcohol, for example, at least one type selected from lower alcohols such as methanol, ethanol, 1-propanol and 1-butanol, or a liquid mixture of two or more types thereof can be exemplified. The solvent 6 of the present embodiment is a mixed solvent containing water, ethanol and 1-propanol.

The solvent 6 of the present embodiment is adjusted so that the solubility parameter thereof (Solubility Parameter, SP value) exceeds 18. Since the solvent 6 is more hydrophilic, and the affinity with the electrolyte membrane 21 constituted mainly by polymer is small, it is possible to reduce the swelling or dissolution of the electrolyte membrane 21 by the solvent 6 in the catalyst ink 10 coated onto the surface of the electrolyte membrane 21.

TABLE 1

| Ratio of alcohol | | | | |
|---|---|---|---|---|
| to water | Water | Ethanol | 1-propanol | SP value |
| 1 | 50% by mass | 33% by mass | 17% by mass | 18.00 |
| 1 | 50% by mass | 34% by mass | 16% by mass | 18.00 |
| 1 | 50% by mass | 35% by mass | 15% by mass | 18.01 |
| 1 | 50% by mass | 36% by mass | 14% by mass | 18.01 |

Table 1 is a table showing the relationship between the composition of the solvent 6 in the catalyst ink 10 and the SP value. The solvent 6 shown in Table 1 is configured from water, ethanol and 1-propanol. As shown in Table 1, in the case of the ratio of alcohol relative to water in the solvent 6 being 50% by mass, it can be confirmed that the SP value exceeds 18 at 35% by mass or more of ethanol.

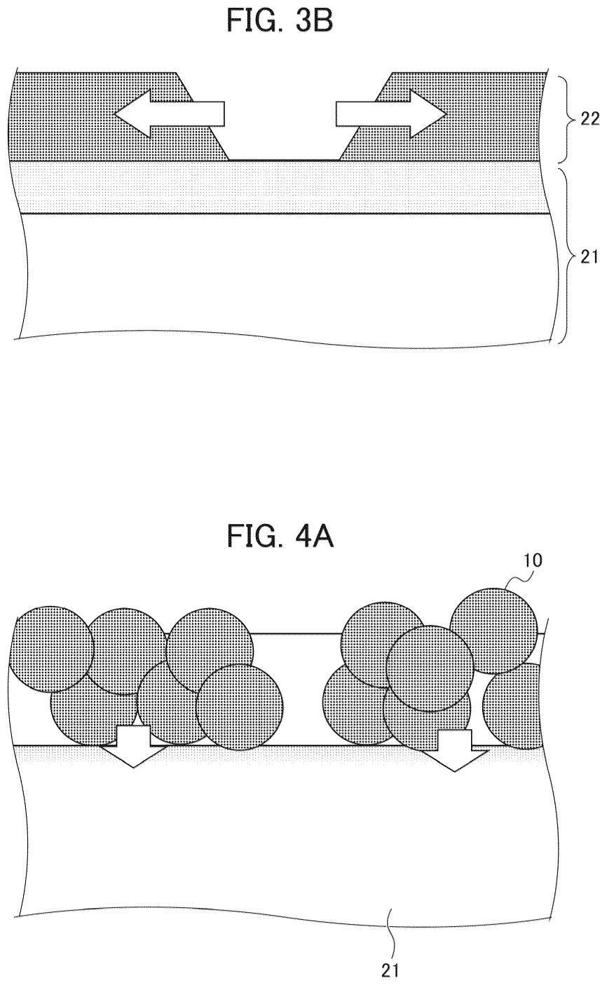

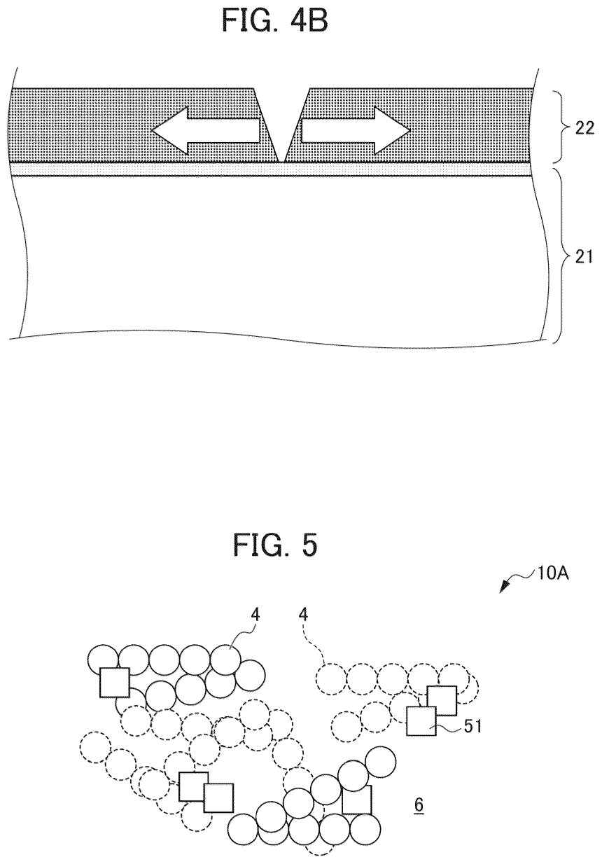

Herein, the relationship of the permeability of the solvent 6 in the catalyst ink 10 to the electrolyte membrane 21 and cracks occurring in the electrolyte membrane 21 will be described while referencing FIGS. 3A to 4B.

FIG. 3A is a schematic diagram showing the penetration status of the solvent 6 in the electrolyte membrane 21 on which a catalyst ink having an SP value of solvent no more than 18 was coated. FIG. 3B is a schematic diagram showing the state of the catalyst layer 22 formed by drying the catalyst ink coated in FIG. 3A. FIG. 4A is a schematic diagram showing the penetration status of the solvent 6 in the electrolyte membrane 21 on which the catalyst ink 10 having an SP value of the solvent 6 exceeding 18 was coated. FIG. 4B is a schematic diagram showing the state of the catalyst layer 22 formed by drying the catalyst ink 10 coated in FIG. 4A. It should be noted that, in FIGS. 3A to 4B, the dots indicate the solvent 6 penetrated into the electrolyte membrane 21.

A catalyst ink having an SP value of the solvent 6 of 18 or less tends to have high affinity to the electrolyte membrane 21, and more of the solvent 6 penetrating inside from the surface of the electrolyte membrane 21, as shown in FIG. 3A. At this time, since the electrolyte membrane 21 swells to become a soft state, the catalyst layer 22 slides at the interface with the electrolyte membrane 21 by way of the shrinkage stress (e.g., force acting in the arrow direction shown in FIG. 3B) of the catalyst ink in the course of drying in order to form the catalyst layer 22, and then cracks such as that shown in FIG. 3B generate in the catalyst layer 22.

On the other hand, the catalyst ink 10 having an SP value of the solvent 6 of 18 or more has lower affinity to the electrolyte membrane 21, and thus the penetration of the solvent 6 from the surface of the electrolyte membrane 21 is reduced as shown in FIG. 4A, and it is possible to suppress swelling and dissolution at the surface of the electrolyte membrane 21. As shown in FIG. 4B, it is thereby possible to suppress a decline in hardness of the surface of the electrolyte membrane 21, and prevent sliding of the catalyst layer 22 at the interface with the electrolyte membrane 21 by shrinkage, etc. of the catalyst ink 10 in the course of drying. Consequently, it is possible to suppress the occurrence of cracks in the catalyst layer 22.

The catalyst ink 10 preferably has a concentration of solid content relative to total amount thereof of 2% by mass or more and 6% by mass or less. By setting the concentration of solid content to 2% by mass or more, there is no longer a necessity for an operation to increase the film thickness during coating, and thus avoids a situation in which cracks tend to occur, and the amount of solvent 6 coated on the electrolyte membrane 21 is reduced, and it is possible to reduce the penetration amount of solvent 6 to the electrolyte membrane 21. In addition, by setting the concentration of solid content to 6% by mass or less, for example, the dispersibility during kneading in the case of using a ball mill or bead mill becomes unlikely to decline, and thus it is possible to prevent a decline in coatability and the occurrence of defects in the formation of the catalyst layer. Solid content of the catalyst ink in the present disclosure includes the catalyst metal particles, the ionomer 4 and the carbon 5 contained in the catalyst ink 10. In addition, concentration of the solid content in the present disclosure refers to the mass percent concentration of the total mass of the catalyst metal particles, the ionomer 4 and the carbon 5 relative to the total mass of the catalyst ink 10.

The concentration of solid content, for example, can be specified by heating the catalyst ink 10 to evaporate the solvent, and calculating the remaining amount after heating relative to the mass of the catalyst ink 10 prior to heating. The concentration of solid content, for example, may be measured using a moisture meter (MOC63u, manufactured by Shimadzu Corp.).

The proportion of the ionomer 4 relative to the total amount of carbon fiber 52 in the catalyst ink 10 (ionomer/carbon fiber 52 overall) is not particularly limited; however, it is preferably 0.003 to 0.2 from the viewpoint of performance and layer formation.

Herein, the dispersion state of each component in the catalyst ink 10 according to the present embodiment will be described while referencing FIGS. 2 and 5. FIG. 5 is a schematic diagram showing the dispersion state of the ionomer 4 in the catalyst ink 10A in which the carbon fiber 52 is not included. It should be noted that, for convenience, FIG. 5 shows the ionomer 4 by both a plurality of continuous solid line circles, and continuous broken line circles, so that it is understood that the plurality of ionomers 4 are dispersed.

In the catalyst ink 10A in which the carbon fiber 52 is not included, as shown in FIG. 5, there is a tendency for the ionomer 4 to combine and agglomerated particles to locally form. When the diameter of the agglomerated particles consisting of a plurality of ionomers 4, etc. increases, cracks starting at this agglomerated particle occur, which is a cause of the strength or function of the catalyst layer 22 to decline.

On the other hand, in the catalyst ink 10 containing the carbon fiber 52, as shown in FIG. 2, the plurality of ionomers 4 are linked also via the carbon fibers 52, and is a state where the ionomers 4 uniformly entangle each other in the catalyst ink 10 overall. In other words, the dispersibility of the ionomer 4 in the solvent 6 is a higher state compared to FIG. 5 due to the carbon fibers 52.

### (Method for Producing Catalyst Ink)

Next, an example of a method for producing the catalyst ink 10 will be described.

First, the ionomer 4, and each solvent 6 of an alcohol such as ethanol or 1-propanol and water were weighed and mixed to prepared a liquid mixture. Next, the carbon particles 51 and carbon fiber 52 on which the catalyst metal particles are supported are weighed, charged to the above liquid mixture, and mixed using a propeller agitator. At this time, each component is mixed and agitated while adjusting the proportion of carbon fiber 52 in the carbon 5 and the SP value of the solvent 6. Next, the liquid mixture with adjusted proportion of carbon fiber 52 and SP value of the solvent 6 is kneaded by a ball mill or bead mill using zirconia. The kneading time may be 24 hours in the case of kneading by a ball mill, for example.

According to the catalyst ink 10 according to the embodiment described above, the following such effects are exerted.

The catalyst ink 10 according to the present embodiment is a catalyst ink 10 which forms the catalyst layer 22 by being coated onto the surface of the electrolyte membrane 21 of the fuel cell 1, and contains the ionomer 4, catalyst metal particles, carbon 5 and solvent 6, in which the solubility parameter of the solvent 6 exceeds 18.0.

Since the solubility parameter exceeds 18.0, it is more hydrophilic, and the affinity to the electrolyte membrane containing polymer, etc. becomes small, it is thereby possible to reduce the swelling or dissolution of the electrolyte membrane 21 by the solvent 6 in the catalyst ink 10 coated on the surface of the electrolyte membrane. Consequently, sliding at the interface with the electrolyte membrane 21 by shrinkage of the catalyst ink 10 in the course of drying after coating of the catalyst ink 10 is suppressed, and thus the occurrence of cracks and wrinkles in the catalyst layer 22 can be suppressed. In addition, it is possible to suppress an increase in the resistance and decline in the power generation property due to mixing of each component at the interface between the electrolyte membrane 21 and the catalyst layer 22. Consequently, it is possible to form the catalyst layer 22 achieving both a stable coated surface quality and function.

In addition, in the catalyst ink 10 according to the present embodiment, the solvent 6 contains water and an alcohol including ethanol, and the concentration of ethanol in the solvent 6 is 35% by mass or more.

It is thereby possible to more easily prepare the catalyst ink 10, which does not induce swelling or dissolution of the electrolyte membrane 21.

In addition, in the catalyst ink 10 according to the present embodiment, the carbon fiber 52 is included in the carbon 5, and the proportion of carbon fiber 52 in the carbon 5 in the catalyst ink 10 is greater than 0% by volume and 10% by volume or less.

Different ionomers 4 in the catalyst ink 10 tend to link together via the carbon fiber 52, and it is thereby possible to maintain the dispersibility of the catalyst ink 10 irrespective of the composition of the solvent 6 and SP value. Consequently, it is possible to decrease the coarse particles and agglomerated particles, and thus prevent the occurrence of cracks in the catalyst layer 10 starting from these, and form a catalyst layer 22 of more stable quality. In addition, no equipment or additional stirring process are necessary for achieving an increase in dispersibility of the ionomer 4 in the catalyst ink 10, and thus the manufacturing cost can be curbed.

Preferred embodiments of the present invention have been described above. However, the present invention is not to be limited to the above embodiments, and modifications thereto are possible where appropriate.

### Examples

Next, the present invention will be described in further detail based on examples; however, the present invention is not to be limited thereto.

### (Evaluation Test of Solvent Absorption Rate)

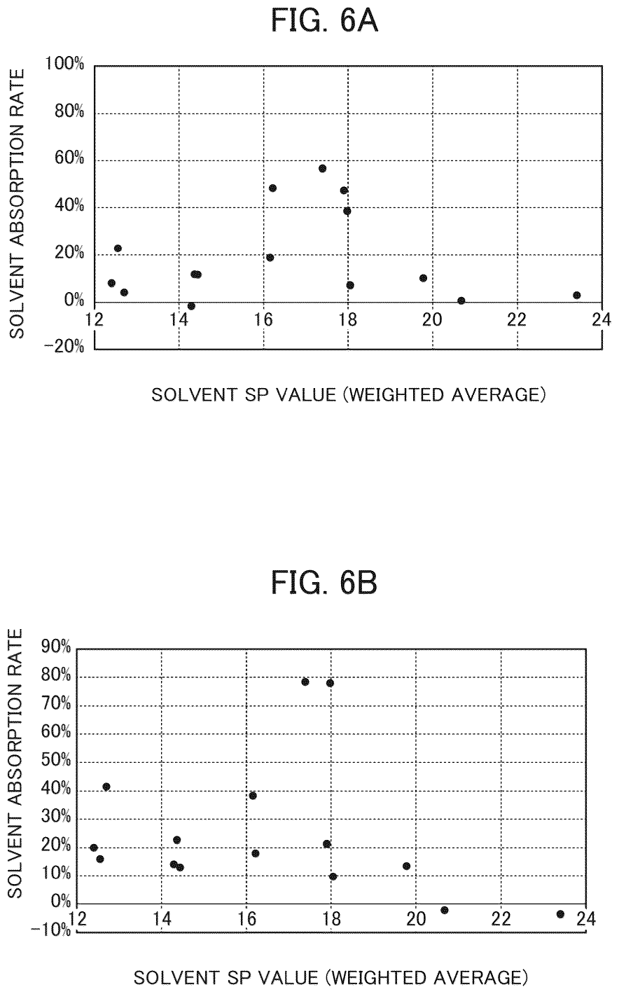

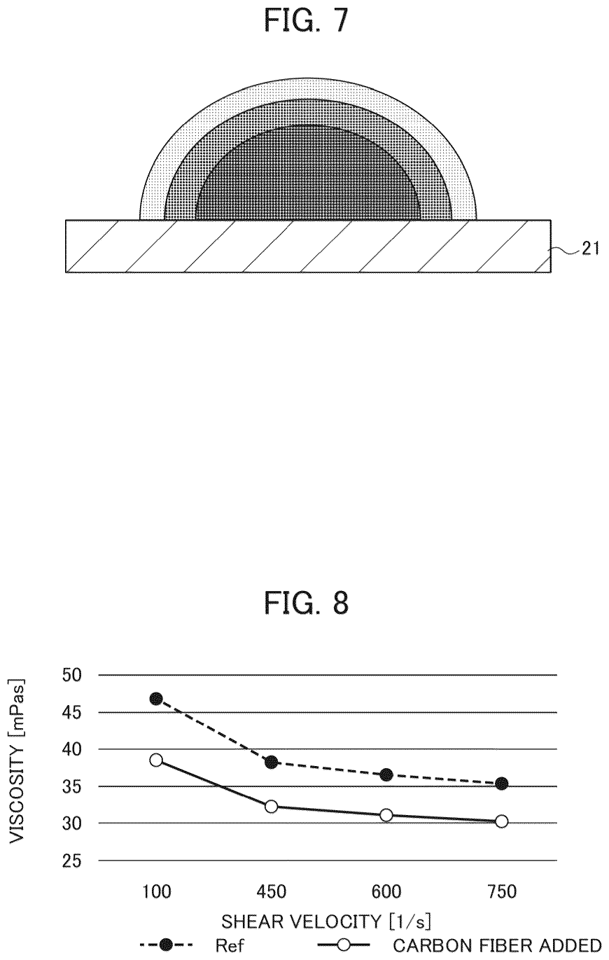

The solvent absorption rate of the electrolyte member relative to the SP value of solvent in the catalyst ink was confirmed. FIGS. 6A and 6B are graphs showing the evaluation results of the solvent absorption rate of the electrolyte membrane relative to the SP value of the solvent of the catalyst ink. The vertical axis of the FIGS. 6A and 6B indicates the solvent absorption rate (%), and the horizontal axis indicates the SP value of the solvent of each catalyst ink. The SP value indicated in FIGS. 6A and 6B is a value achieved by weighted averaging the SP value of each solvent in the catalyst ink by setting the proportion of each solvent as the weight. FIG. 6A shows the evaluation results of the solvent absorption rate of an electrolyte membrane B, and FIG. 6B shows the evaluation results of the solvent absorption rate of an electrolyte membrane C. The electrolyte membrane B and the electrolyte membrane C are both formed by a reinforcement layer sandwiched on both surfaces in the thickness direction by layers of ionomer. The reinforcement layer is expanded polytetrafluoroethylene (ePTFE).

### <Preparation of Ink>

The ink used in the confirmation test of the solvent absorption rate was prepared as follows. First, an aqueous dispersion of ionomer, ethanol and 1-propanol were weighed, and poured to a container. Then, the solution in the container was mixed and agitated using a propeller agitator to prepare the ink used in the evaluation test of the solvent absorption rate. By adjusting the added amounts of ethanol and 1-propanol, it was adjusted to the SP value of each ink shown in FIGS. 6A and 6B.

### <Evaluation Method>

FIG. 7 is a view showing a drop of ink coated on the electrolyte membrane, and is an explanatory diagram for describing a method for obtaining the solvent absorption rate of the electrolyte membrane. For the solvent absorption amount in the electrolyte membrane 21, the prepared ink was dropped onto the surface of the electrolyte membranes B and C, and the dimensions of this droplet on the electrolyte membranes B and C were confirmed by optical microscope or the like. Then, based on the confirmed dimensions of the droplet, the change in volume of the droplet was calculated by the following formula (1), and the solvent absorption rate A of the electrolyte membrane was calculated by the following formula (2).

$$A 1 = V 0 - V 1 - V 2 \qquad Formula ( 1 )$$

$$A = ( A 1 / V 0 ) \times 100 \qquad Formula ( 2 )$$

It should be noted that Al is the absorbed amount of the electrolyte membrane (region indicated by second densest dots in FIG. 7), V0 is the volume immediately after dropping to the electrolyte membrane (region from densest dots to sparsest dots in FIG. 7), V1 is the volume 60 seconds after dropping (region indicated by densest dots in FIGS. 7), and V2 is the volatilization volume of the solvent 6 in 60 seconds from dropping.

### <Evaluation Results>

As shown in FIGS. 6A and 6B, in a range of SP value of the ink greater than 16 and less than 18, it could be confirmed that the solvent absorption rate of both the electrolyte membranes B and C was high. In addition, in both the electrolyte membranes B and C, it was confirmed that the solvent absorption rate significantly decreases when the SP value exceeds 18.

### (Evaluation Test of Viscosity and Particle Size)

The influence of carbon fiber on the viscosity and particle size of the catalyst ink was confirmed.

### <Preparation of Catalyst Ink>

The catalyst ink used in the evaluation tests for viscosity and particle size was prepared as follows. First, the aqueous dispersion of ionomer, and ethanol, 1-propaneol and water as the solvent were weighed, and poured in a container. Next, the carbon particles and carbon fiber on which the catalyst metal particles are supported were weighed and charged into a container, and were mixed and agitated under a nitrogen atmosphere using a propeller agitator together with the aqueous dispersion of the ionomer and each solvent. Next, the mixed and agitated liquid mixture was kneaded with a ball mill or bead mill using zirconia. VGCF (manufactured by Showadenkosya Co. Ltd.) was used as the carbon fiber. An ink adjusted so that the carbon fiber in the catalyst ink became 10% by volume relative to the total carbon including the carbon particles, and the SP of the solvent became 17.97 was established as Sample 1. On the other hand, an ink identical to Sample 1 except for the point of not containing the carbon fiber was established as Sample 2.

### <Evaluation Method of Viscosity>

Regarding the viscosity, the viscosity after agitating each of Sample 1 and Sample 2 with a shear velocity of 100 (1/s), 450 (1/s), 600 (1/s) and 700 (1/s) was measured with a cone-plate type viscometer (rheometer).

### <Evaluation Method of Particle Size>

For the particle size, the particle size of each of Sample 1 and Sample 2 was measured by a granulometer (manufactured by Shimadzu Corp.).

### <Evaluation Results>

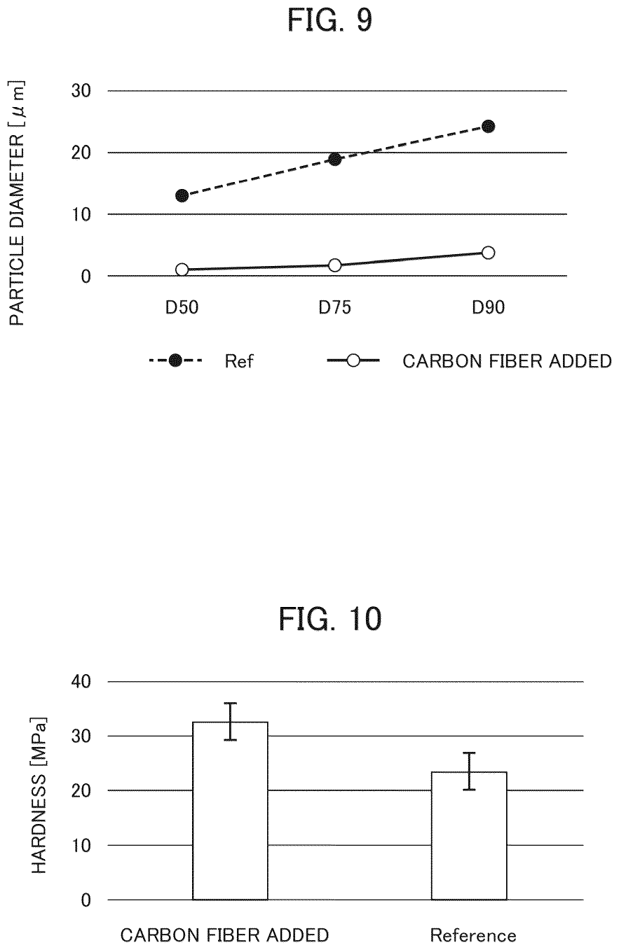

FIG. 8 is graph showing the evaluation results for the viscosities of Samples 1 and 2. The vertical axis of FIG. 8 indicates the viscosity (mPas) of the catalyst ink, and the horizontal axis indicates the shear velocity (1/s). As shown in FIG. 8, the viscosity of the catalyst ink was confirmed to decline at all shear velocities more for the catalyst ink of Sample 1 containing carbon fiber than Sample 2 which does not contain carbon fiber. FIG. 9 is a graph showing the evaluation results of particle size distribution of Samples 1 and 2. The vertical axis in FIG. 9 indicates the particle diameter (μm) of the catalyst ink, and the horizontal axis indicates D50, D75 and D90. As shown in FIG. 9, the catalyst ink of Sample 1 containing carbon fiber was confirmed to have smaller particle diameters. Consequently, an improvement in dispersibility of the catalyst ink by carbon fiber could be confirmed from the evaluation tests for viscosity and particle size.

### (Hardness Evaluation Test for Catalyst Layer)

The influence of carbon fiber on the hardness of the catalyst layer was confirmed.

### <Preparation of Catalyst Layer>

The catalyst layer used in the hardness evaluation test was prepared as follows. A catalyst layer of Sample 3 was prepared by coating the above Sample 1 as the catalyst ink on the surface of an electrolyte membrane, and then drying in a batch oven. A catalyst layer of Sample 4 was prepared by coating the above Sample 2 as the catalyst ink on the surface of an electrolyte membrane, and then drying in a batch oven.

### <Hardness Evaluation Method>

The hardnesses of the catalyst layers of Samples 3 and 4 were measured by micro-indent test using a nanoindenter (manufactured by Anton Paar GmbH).

### <Evaluation Results>

FIG. 10 is a graph showing the hardnesses of Samples 3 and 4. The vertical axis of FIG. 10 indicates the hardness (Mpa) of the catalyst layer. As shown in FIG. 10, it could be confirmed that the hardness was higher for the catalyst layer of Sample 3 formed by the catalyst ink containing carbon fiber, than the catalyst layer formed by the catalyst ink not containing carbon fiber. This is surmised to be due to crosslinking of the ionomer 4 in the catalyst ink 10 being more abundantly formed by an improvement in dispersibility of the ionomer 4 from the carbon fiber.

### (Evaluation Test of Crack Occurrence Rate in Catalyst Layer)

The influence of carbon fiber on the crack occurrence rate in the catalyst layer was confirmed.

### <Preparation of Catalyst Layer>

The catalyst layer used in the evaluation test of crack occurrence rate was prepared as follows. The catalyst layer was prepared by coating, on the electrolyte membrane, a catalyst ink prepared by the same method as the above Sample 1 except for the added amount of carbon fiber, and then drying in a batch oven. Three types of catalyst layers were prepared using catalyst inks in which the proportion of the carbon in the catalyst ink occupied by carbon fiber was 0% by volume, 10% by volume, and 20% by volume, respectively.

### <Evaluation Method of Crack Occurrence Rate>

The crack occurrence rate of the catalyst layer was evaluated by the following method. First, the prepared catalyst layer was placed on a light board, and photographed from directly above. Next, the occupied area of cracks was calculated by cutting out an area of the catalyst layer from the obtained image, and binarization processing on the image by ImageJ, and the proportion of the occupied area of cracks relative to the area of the cutout catalyst layer was defined as the crack occurrence rate.

### <Evaluation Results>

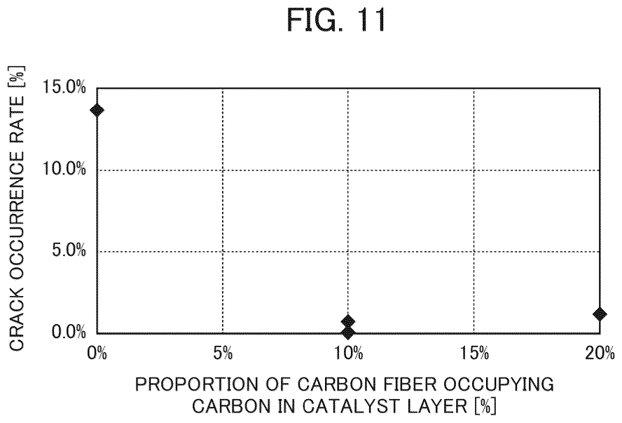

FIG. 11 is a graph showing the relationship between the proportion of carbon fiber to carbon in the catalyst layer, and the crack occurrence rate. As shown in FIG. 11, relative to the catalyst layer formed by the catalyst ink in which carbon fiber is not contained, which had a crack occurrence rate of 13% or more, it was confirmed that the catalyst layer formed by the catalyst ink in which the carbon fiber was 10% of the carbon could reduce the crack occurrence rate to about 2% or less. It was confirmed that, with the catalyst layer formed by the catalyst ink having an increased proportion of carbon fiber among the carbon to 208, the crack occurrence rate was substantially the same as a case in which the proportion of carbon fiber was 10%.

### EXPLANATION OF REFERENCE NUMERALS

1 fuel cell
4 ionomer
5 carbon
6 solvent
10 catalyst ink
52 carbon fiber

What is claimed is:

1. A catalyst ink for forming a catalyst layer by coating onto a surface of an electrolyte membrane of a fuel cell, the catalyst ink comprising:
an ionomer; catalyst metal particles; carbon; and a solvent,
wherein a solubility parameter of the solvent is greater than 18.0.

2. The catalyst ink according to claim 1, wherein the solvent includes water and an alcohol containing at least ethanol,
wherein a concentration of ethanol in the solvent is 35% by mass or more.

3. The catalyst ink according to claim 1, wherein the carbon includes carbon fiber, and
wherein a proportion of the carbon fiber in the carbon in the catalyst ink is greater than 0% by volume and 10% by volume or less.

4. The catalyst ink according to claim 2, wherein the carbon includes carbon fiber, and
wherein a proportion of the carbon fiber in the carbon in the catalyst ink is greater than 0% by volume and 10% by volume or less.
